(19) United States
(12) Patent Application Publication
(10) Pub. No.: US 2019/0072806 A1
(43) Pub. Date: Mar. 7, 2019

(54) Display panel, display device, and smart watch

(71) Applicant: BOE Technology Group Co., Ltd., Beijing (CN)

(72) Inventor: Xiao Zhang, Beijing (CN)

(21) Appl. No.: 15/736,394

(22) PCT Filed: May 9, 2017
(86) PCT No.: PCT/CN2017/083561

§ 371 Date: Dec. 14, 2017

(30) Foreign Application Priority Data
Jun. 24, 2016 (CN) 201610471958.8

(51) Int. Cl. G02F 1/137; G02F 1/1347; G04G 9/00; G04G 9/12; G06F 1/32

(52) U.S. Cl. CPC G02F 1/13718; G02F 1/13473; G06F 1/3265; G04G 9/12; G04G 9/0041

(57) ABSTRACT

The present disclosure relates to a display panel, a display device and a smart watch, wherein, the display panel includes a liquid crystal display panel; and a light-exiting surface of the liquid crystal display panel is provided with a cholesteric liquid crystal display film layer; wherein, the cholesteric liquid crystal display film layer is switchable between a scattering state and a transparent state depending on a voltage applied thereto, and is used for displaying by means of its scattering state when the liquid crystal display panel is powered off.

### CROSS REFERENCE

The present disclosure claims a priority benefit of Chinese Patent Application No. 201610471958.8, filed on Jun. 24, 2016, the entire content thereof being incorporated herein by reference.

### TECHNICAL FIELD

The present disclosure relates to the technical field of display device, and particularly to a display panel, a display device and a smart watch.

### BACKGROUND ART

As communication technologies and smart products emerge in an endless stream, smart wearable devices such as smart watch and the like are more and more popular, and a large number of smart wearable devices come into our daily life increasingly. In particular, various smart watches represented by children's watches and business smart watches grow explosively.

Smart watches are distinguished from conventional watches mostly in that the smart watches not only have the function of displaying time, but also can function similar to a mobile phone or a computer to display a color image, which is achieved mainly by means of current mature liquid crystal display technology. Smart watches can be connected to network by a built-in smart system or via a smart phone system, so as to implement multiple functions, such as synchronizing phone call, short message, mail, photo and music in a mobile phone, and displaying Twitter, news, weather, or the like through connecting with internet.

However, the existing smart watches, especially the backlight sources thereof, have large power consumption. Once the battery runs out and it is not charged in time, even the fundamental function of time displaying is unachievable. If the user powers off the liquid crystal display screen of the smart watch when not in use, for the purpose of lowering power consumption, it is conflicting with the conventional function of the watch—displaying time.

### SUMMARY

The present disclosure provides the following technical solutions.

A first aspect of the present disclosure provides a display panel comprising a liquid crystal display panel; and

a light-exiting surface of the liquid crystal display panel is provided with a cholesteric liquid crystal display film layer,

wherein, the cholesteric liquid crystal display film layer is switchable between a scattering state and a transparent state depending on a voltage applied thereto, and is used for displaying by means of its scattering state when the liquid crystal display panel is powered off.

Optionally, the cholesteric liquid crystal display film layer comprises a first substrate and a second substrate disposed with cells aligned, and a cholesteric liquid crystal layer disposed between the first substrate and the second substrate, wherein the cholesteric liquid crystal display film layer comprises at least one display region, and the display region is filled with cholesteric liquid crystal.

Optionally, the second substrate and a color film substrate of the liquid crystal display panel share a substrate.

Optionally, the cholesteric liquid crystal may be a cholesteric liquid crystal reflecting ultraviolet ray or infrared ray.

Optionally, the display region comprises a plurality of pixel units;

the pixel unit comprises a first electrode and a second electrode;

the first electrode is disposed on one side of the first substrate close to the cholesteric liquid crystal layer; and

the second electrode is disposed on one side of the second substrate close to the cholesteric liquid crystal layer.

Optionally, a first separating pillar is disposed between adjacent pixel units.

Optionally, the cholesteric liquid crystal display film layer further comprises a non-display region, and a second separating pillar is disposed between the display region and the non-display region.

A second aspect of the present disclosure provides a display device comprising any one of the display panels described above.

A third aspect of the present disclosure provides a smart watch comprising the display device described above.

A fourth aspect of the present disclosure provides a method for manufacturing a display device, comprising forming a cholesteric liquid crystal display film layer on a light-exiting surface of a liquid crystal display panel.

A fifth aspect of the present disclosure provides a display method for the display panels described above, the method comprising:

applying a first voltage to the cholesteric liquid crystal display film layer to allow the cholesteric liquid crystal display film layer to present a scattering state when the liquid crystal display panel is powered off.

Optionally, the method further comprises:

applying a second voltage to the cholesteric liquid crystal display film layer to which the first voltage is applied, to allow the cholesteric liquid crystal display film layer to present a transparent state when the liquid crystal display panel is powered on.

### BRIEF DESCRIPTION OF DRAWINGS

To more clearly illustrate the technical solutions in the embodiments of the present disclosure or in prior art, the drawings to be used in the description of the embodiments or prior art will be briefly introduced below. Obviously, the drawings in the following description are only some embodiments of the present disclosure, and other drawings can be obtained by those skilled in the art according to these drawings without inventive efforts.

FIG. 1 shows a structural schematic diagram of a display panel provided in one embodiment of the present disclosure;

FIG. 2 is a schematic diagram showing the effect of displaying a clock by a cholesteric liquid crystal display film layer when the backlight source is powered off, as provided in one embodiment of the present disclosure;

FIG. 3 shows a structural schematic diagram of a cholesteric liquid crystal display film layer in a display panel provided in one embodiment of the present disclosure;

FIG. 4 shows a structural schematic diagram of a cholesteric liquid crystal display film layer in a display panel provided in another embodiment of the present disclosure; and

FIG. 5 shows a structural schematic diagram of a cholesteric liquid crystal display film layer in a display panel provided in still another embodiment of the present disclosure.

### DETAILED DESCRIPTION

In order to make the objects, technical solutions and advantages of the embodiments of the present disclosure more clear, detailed descriptions are made below in combination with the drawings of the embodiments of the present disclosure. Obviously, the embodiments described are only a part of, not all of the embodiments of the present disclosure. All of other embodiments obtained by those skilled in the art based on the embodiments described, without inventive efforts, fall within the protection scope of the present disclosure.

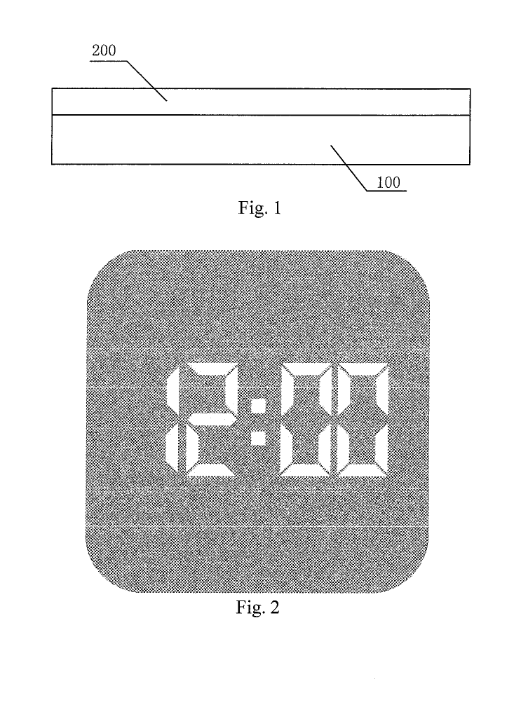

FIG. 1 shows a structural schematic diagram of a display panel provided in one embodiment of the present disclosure. As shown in FIG. 1, the display panel of this embodiment comprises a liquid crystal display panel 100; and a light-exiting surface of the liquid crystal display panel 100 is provided with a cholesteric liquid crystal display film layer 200; wherein, the cholesteric liquid crystal display film layer 200 is used for displaying when the liquid crystal display panel 100 is powered off.

Particularly, cholesteric liquid crystal (CLC) has three morphologies of planar texture, focal conic state texture and field-induced nematic phase. Here, the planar texture is characterized in that it reflects a light having a certain wavelength without any voltage applied, i.e. in the state of zero electric field, and the wavelength λ of the light reflected is related to the pitch p and the average reflectivity n (see equation (1) below), that is, the greater p of CLC, the longer λ of the reflected light is. On the other hand, focal conic state texture is formed by applying a certain voltage to CLC, and this kind of texture can remain stable after the voltage is removed. Field-induced nematic phase is obtained by applying a certain voltage to the focal conic state, and is characterized in that it can be recovered to a planar texture after the voltage is removed immediately.

λ=n×p (1)

wherein, λ is the wavelength of the reflected light, n is the average reflectivity, and p is the pitch.

The display panel of this embodiment presents state 1 (i.e. a transparent state) when no voltage is applied, presents state 2 (i.e. a white color state) when voltage V1 is applied, and returns to state 1 after voltage V2 is applied and then removed. In the present disclosure, the cholesteric liquid crystal can present state 1 because it reflects ultraviolet ray or infrared ray.

Particularly, when only a clock is needed to be displayed, the cholesteric liquid crystal display film layer 200 can present a scattering state (state 2, white color, see FIG. 2) by powering off the backlight source of the liquid crystal display panel and applying a voltage to the cholesteric liquid crystal display film layer 200. Because state 2 (a focal conic state) is stable, that is, state 2 formed after voltage V1 is applied can remain when the voltage V1 is then removed, the state of displaying the clock is power saving.

It can be understood that in addition to displaying a clock, the cholesteric liquid crystal display film layer of this embodiment can also be used for displaying other contents set according to user's requirements, including but not limited to any one of the following items and a combination thereof:

date, alarm clock and notification message.

Obviously, displaying the above contents by the cholesteric liquid crystal can also be achieved in a manner of displaying the required information by the cholesteric liquid crystal display film layer when the liquid crystal display screen is powered off, and normally displaying the contents of the liquid crystal display screen of the smart watch when the liquid crystal display screen is powered on, thereby achieving the purpose of reducing the power consumption of display devices such as smart watch and the like.

When it is needed to use the liquid crystal display panel 100 to display, it is only required to apply voltage V2 to the cholesteric liquid crystal display film layer 200 and then remove the voltage, allowing the cholesteric liquid crystal to return to the transparent state 1, and power on the backlight source of the display panel 100.

In the display panel of this embodiment, because the cholesteric liquid crystal display film layer is disposed on the light-exiting surface of the liquid crystal display panel and different display states (the scattering state and the transparent state) of the cholesteric liquid crystal are switchable by changing the voltage applied, time can be displayed by the cholesteric liquid crystal (in the scattering state) when the liquid crystal display screen is powered off, and the contents of the liquid crystal display screen of the smart watch can be normally displayed when the liquid crystal display screen is powered on, thereby the purpose of reducing the power consumption of the display device such as a smart watch and the like is achievable.

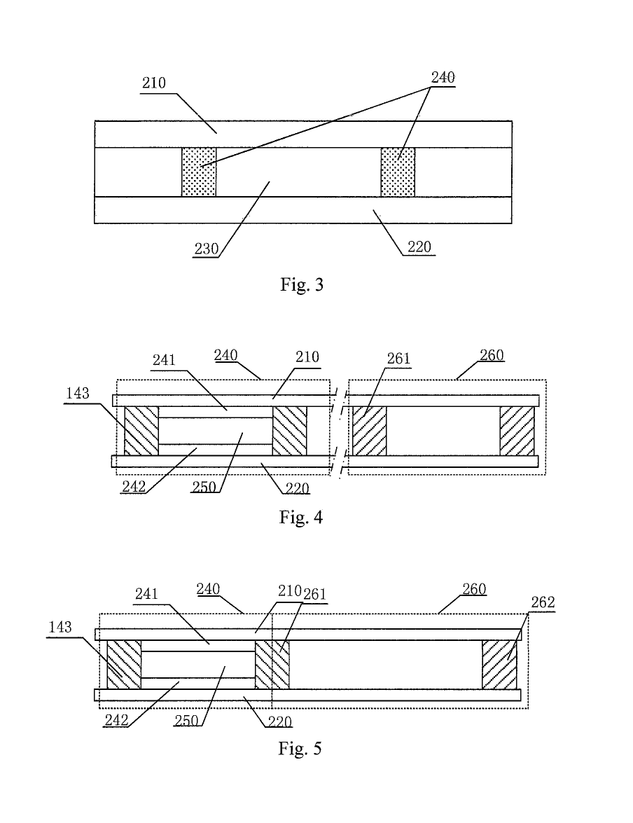

FIG. 3 shows a structural schematic diagram of a cholesteric liquid crystal display film layer in a display panel provided in one embodiment of the present disclosure. As shown in FIG. 3, based on the above embodiment, the cholesteric liquid crystal display film layer 200 may further comprises a first substrate 210 and a second substrate 220 disposed with cells aligned, and a cholesteric liquid crystal layer 230 disposed between the first substrate 210 and the second substrate 220, wherein the cholesteric liquid crystal layer 230 comprises at least one display region 240, and the display region 240 is filled with cholesteric liquid crystal which can reflect ultraviolet ray or infrared ray.

It should be noted that in this embodiment, disposing the first substrate 210 and the second substrate 220 with cells aligned may be achieved by any known display panel manufacture process, and it is not limited in the present disclosure.

Further, as a preference of this embodiment, the second substrate 220 and a color film substrate of the liquid crystal display panel share one substrate, for the purpose of reducing the thickness of the display panel and saving the production cost.

FIG. 4 shows a structural schematic diagram of a cholesteric liquid crystal display film layer in a display panel provided in one embodiment of the present disclosure; and FIG. 5 shows a structural schematic diagram of a cholesteric liquid crystal display film layer in a display panel provided in another embodiment of the present disclosure. As shown in FIG. 4 and FIG. 5, based on the above embodiments, the display region 240 may comprises a plurality of pixel units; particularly, the pixel unit comprises a first electrode 241 and a second electrode 242;

the first electrode 241 is disposed on one side of the first substrate 210 close to a cholesteric liquid crystal layer 250;

the second electrode 242 is disposed on one side of the second substrate 220 close to the cholesteric liquid crystal layer 250; and

the cholesteric liquid crystal layer 250 is disposed between the first electrode 241 and the second electrode 242.

Further, as a preference of this embodiment, a first separating pillar 143 is disposed between the adjacent pixel units. Here, the first separating pillar 143 can function to support the first substrate 210 and the second substrate 220, and separate different filling regions of the cholesteric liquid crystal from each other.

Further, as a preference of this embodiment, the cholesteric liquid crystal display film layer 200 further comprises a non-display region 260, wherein, a second separating pillar 261 is disposed between the display region 240 and the non-display region 260. The second separating pillar 261 can act as a separator between the display region and the non-display region to effectively prevent the liquid crystal in the display region from moving towards the non-display region. In addition, as shown in FIG. 5, a separating pillar 262 may also be disposed in the non-display region to act as a spacer supporting the first substrate and the second substrate, so as to effectively prevent the display panel from being deformed due to squeezing such that the substrate is damaged.

In a second aspect, the embodiments of the present disclosure provide a display device comprising any one of the display panels described above. Particularly, the display device may include any product or component having a displaying function suitable for products such as electronic paper, mobile phone, smart watch, tablet computer, television, display, notebook, digital photo frame, navigator and the like.

In a third aspect, the embodiments of the present disclosure provide a smart watch comprising the display device described above.

In a fourth aspect, the embodiments of the present disclosure provide a method for manufacturing a display device, comprising forming a cholesteric liquid crystal display film layer on a light-exiting surface of a liquid crystal display panel.

In a fifth aspect, the embodiments of the present disclosure provide a display method for the display panels described above, the method comprising:

applying a first voltage to the cholesteric liquid crystal display film layer to allow the cholesteric liquid crystal display film layer to present a scattering state when the liquid crystal display panel is powered off.

Further, as a preference of this embodiment, the method described above may further comprise:

applying a second voltage to the cholesteric liquid crystal display film layer to which the first voltage is applied, to allow the cholesteric liquid crystal display film layer to present a transparent state when the liquid crystal display panel is powered on.

Because the cholesteric liquid crystal display film layer is disposed on the light-exiting surface of the liquid crystal display panel and different display states (the scattering state and the transparent state) of the cholesteric liquid crystal are switchable by changing the voltage applied, displaying by the cholesteric liquid crystal (in the scattering state) can be carried out when the liquid crystal display screen is powered off, and the contents of the liquid crystal display screen of a display device such as a smart watch can be normally displayed when the liquid crystal display screen is powered on, thereby the purpose of reducing the power consumption of the display device is achievable.

It should be noted that relational terms such as “first” and “second” herein are only intended to distinguish one entity or operation from another entity or operation, but it is not required or implied that these entities or operations have any practical relation or sequence of this kind. And, the terms “comprise”, “include” or any other variants thereof are intended to cover non-exclusive inclusion, such that a process, method, article or device comprising a series of elements not only comprises those elements, but also comprises other elements not specifically listed, or also comprises elements inherent for the process, method, article or device. Without more limitations, elements defined by phrase “comprising a/an . . . ” do not exclude that there is also an additional equivalent element in the process, method, article or device comprising the element. Direction or position relationship indicated by term “up”, “down” or the like is only for the purpose of describing the present disclosure conveniently and simplifying the description, but it does not indicate or imply that the referred device or member must have a particular direction or position, or be constructed or operated in a particular direction or position. As a result, it should not be interpreted as limiting the present disclosure. Unless specified and defined otherwise, term “installing”, “connecting”, or “linking” should be broadly interpreted, for example, it can be fixedly connecting, detachably connecting, integrally connecting; it can be mechanical connection or electric connection; and it can be directly connecting, connecting via an intermediate, or connecting inside two members. Those skilled in the art can understand the particular meanings of the above terms in the present disclosure according to particular circumstances.

In the description of the present disclosure, a great number of details are described. However, it can be appreciated that the embodiments of the present disclosure can be implemented without these details. In some embodiments, methods, structures and technologies well known in the art are not specifically shown, in order not to obscure the description of the present disclosure. Similarly, it should be understood that in order to simplify the present disclosure and help understand one or more of various aspects of the present disclosure, various features of the present disclosure are sometimes grouped into individual embodiment, figure, or description thereof in the above description of the exemplary embodiments of the present disclosure.

Finally, it should be noted that various embodiments above are only used for illustrating the technical solutions of the present invention, but not for limiting the present invention. Although the present disclosure is described in detail with reference to various embodiments above, those skilled in the art should appreciate that changes can be made on the technical solutions described in those various embodiments above, or a part of or all of the technical features therein can be equivalently substituted; and these changes or substitutions will not depart corresponding technical solutions from the spirit of the present invention, and all of them should fall within the scope of the present invention.

1. A display panel comprising:
a liquid crystal display panel; and
a cholesteric liquid crystal display film layer provided on a light-exiting surface of the liquid crystal display panel;
wherein, the cholesteric liquid crystal display film layer is switchable between a scattering state and a transparent state depending on a voltage applied thereto, and is used for displaying by means of its scattering state when the liquid crystal display panel is powered off.

2. The display panel according to claim 1, wherein, the cholesteric liquid crystal display film layer comprises a first substrate and a second substrate disposed with cells aligned, and a cholesteric liquid crystal layer disposed between the first substrate and the second substrate, wherein, the cholesteric liquid crystal display film layer comprises at least one display region, and the display region is filled with cholesteric liquid crystal.

3. The display panel according to claim 2, wherein, the second substrate and a color film substrate of the liquid crystal display panel share a substrate.

4. The display panel according to claim 2, wherein, the cholesteric liquid crystal is a cholesteric liquid crystal reflecting ultraviolet ray or infrared ray.

5. The display panel according to claim 2, wherein, the display region comprises a plurality of pixel units;
the pixel unit comprises a first electrode and a second electrode;
the first electrode is disposed on one side of the first substrate close to the cholesteric liquid crystal layer; and
the second electrode is disposed on one side of the second substrate close to the cholesteric liquid crystal layer.

6. The display panel according to claim 5, wherein, a first separating pillar is disposed between adjacent pixel units.

7. The display panel according to claim 2, wherein, the cholesteric liquid crystal display film layer further comprises a non-display region, and a second separating pillar is disposed between the display region and the non-display region.

8. A display device comprising the display panel according to claim 1.

9. A smart watch comprising the display device according to claim 8.

10. A method for manufacturing a display device, comprising forming a cholesteric liquid crystal display film layer on a light-exiting surface of a liquid crystal display panel, wherein, the cholesteric liquid crystal display film layer is switchable between a scattering state and a transparent state depending on a voltage applied thereto, and is used for displaying by means of its scattering state when the liquid crystal display panel is powered off.

11. A display method for the display panel according to claim 1, the method comprising:
applying a first voltage to the cholesteric liquid crystal display film layer to allow the cholesteric liquid crystal display film layer to present a scattering state when the liquid crystal display panel is powered off.

12. The display method according to claim 11, wherein, the method further comprises:
applying a second voltage to the cholesteric liquid crystal display film layer to which the first voltage is applied, to allow the cholesteric liquid crystal display film layer to present a transparent state when the liquid crystal display panel is powered on.

13. A display device comprising the display panel according to claim 2.

14. A display device comprising the display panel according to claim 3.

15. A display device comprising the display panel according to claim 4.

16. A display device comprising the display panel according to claim 5.

17. A smart watch comprising the display device according to claim 13.

18. A smart watch comprising the display device according to claim 14.

19. A smart watch comprising the display device according to claim 15.

20. A smart watch comprising the display device according to claim 16.
